(19) United States
(12) Patent Application Publication
(10) Pub. No.: US 2026/0253118 A1
(43) Pub. Date: Aug. 27, 2026

(54) GENERATIVE ARTIFICIAL INTELLIGENCE-BASED SEARCH COMPARISONS

(71) Applicant: INTERNATIONAL BUSINESS MACHINES CORPORATION, Armonk, NY (US)

(72) Inventors: Deepa Jain, Gurgaon (IN); Divya Goteti, Hyderabad (IN); VenkataBalagopal Thotakura, Hyderabad (IN)

(21) Appl. No.: 19/061,778

(22) Filed: Feb. 24, 2025

(51) Int. Cl. G06Q 30/0601; G06F 3/0482; G06N 20/00

(52) U.S. Cl. CPC G06Q 30/0629; G06F 3/0482; G06N 20/00

(57) ABSTRACT

An automated method of comparing search results includes identifying, by a chain of interconnected machine learning models (MLMs), features from data generated by a search engine. The features characterize attributes of a plurality of items designated by a user for comparison. The features are grouped by another chain of interconnected MLMs. Each group includes the like features of each of the items. The like features characterize a specific attribute of each of the items. Inter-feature comparisons of like features within each group are performed by a comparative MLM. A generative AI model generates a comparative search result report based on the inter-feature comparisons. The comparative search result report summarizes the inter-feature comparisons of specific attributes of each of the items and is output to the user.

### BACKGROUND

This disclosure relates to information processing and, more particularly, to using generative artificial intelligence (AI) to automate comparisons of data gathered by a search engine.

The phenomenal growth of the Internet has been accompanied by the development of ever more sophisticated search engines. Search engines typically implement so-called “crawlers” or “spiders” that search web pages and gather information, indexing and storing the information collected. In response to a user query, a search engine is able relatively quickly to retrieve the information and deliver a list of results that match the user query.

### SUMMARY

In one or more embodiments, a method of comparing search results includes identifying, by a chain of interconnected machine learning models (MLMs), features from data generated by a search engine. The features characterize attributes of a plurality of items designated by a user for comparison. The features are grouped by another chain of interconnected MLMs. Each group includes the like features of each of the items. The like features characterize a specific attribute of each of the items. Inter-feature comparisons of like features within each group are performed by a comparative MLM. A generative AI model generates a comparative search result report based on the inter-feature comparisons. The comparative search result report summarizes the inter-feature comparisons of specific attributes of each of the items and is output to the user.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example of a computing environment that is capable of implementing a generative AI-based comparison (GAIC) framework.

FIG. 2 illustrates an example architecture of the GAIC framework.

FIG. 3 illustrates an example method of operation of the GAIC framework of FIG. 2.

FIG. 4 illustrates an example graphical user interface (GUI) generated by the GAIC framework of FIG. 2.

### DETAILED DESCRIPTION

While this disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to information processing and, more particularly, to using generative artificial intelligence (AI) to automate comparisons of data gathered by a search engine. Users frequently employ search engines to gather information that the users wish to compare for some purpose, such as selecting an item for purchase. A user looking to purchase an automobile, for example, may search the Internet to identify the different models available. An item of interest need not be limited to products, however. A user may be interested in enrolling in a college course, for example, and may use a search engine to discover course offerings of one or more local colleges. Similarly, a user needing eye surgery may use a search engine to search the Internet for information regarding the various surgical techniques available.

Typically, the search engine delivers of a list of the items of interest, but it is the user who must manually compare the items if seeking to identify the item whose attributes most closely match those desired by the user. Such manual comparisons are often difficult and almost always time-consuming. Moreover, given that the search engine typically gathers information from proprietary websites or other online data sources the information may be biased. The timeliness of the information may be problematic, as well, depending on how frequently the websites and online data sources are updated. Given the difficulty encountered by a user attempting to skim through all the many sources of information and identify all relevant attributes, any such manual comparison is very likely to be limited to only the most frequently referred-to information and may cause the user to miss some niche but nonetheless critical aspects.

In accordance with the inventive arrangements described herein, methods, systems, and computer program products are provided that are capable of comparing similar features of different items identified by a search engine and automatically generating a comparative search result report. An aspect of the inventive arrangements is the automated comparing of search results using a multi-model framework linking multiple machine learning models. The different machine learning models may be separately trained to perform discrete tasks such as keyword (feature) extraction, pattern recognition, sentiment analysis, and other machine learning tasks. The machine learning models, in certain arrangements, include one or more large language models (LLMs). The outputs of comparisons generated by the multiple machine learning models may be fed as input into a generative AI model, the outputs serving as prompts for the generative AI model to automatically output the comparative search result report.

A technical advantage of the inventive arrangements is the automated comparison of similar features of different items of interest without the need for user input beyond specifying the type of the items to be compared. Unlike conventional technologies that merely list the pros and cons of different items, the inventive arrangements compare the different items feature-by-feature. The data from which the features are identified by the inventive arrangements for different items may be textual data, audio data, images and/or video. The inventive arrangements are capable of providing side-by-side comparisons of the different items. In various arrangements, the automatically generated comparative search result report may comprise text, audio, images, and/or audio-video. The comparative search result report is generated using a generative AI model.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the inventive arrangement are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

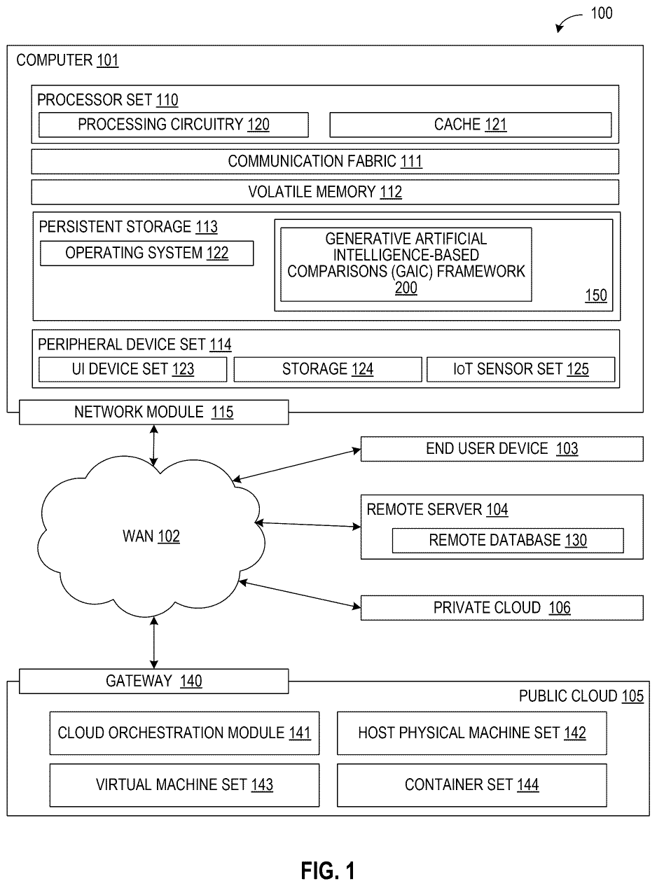

Referring to FIG. 1, computing environment 100 contains an example of an environment for the execution of at least some of the computer code illustrated at block 150 that is involved in performing the inventive methods disclosed herein. The inventive methods performed with the computer code of block 150 can include implementing a generative AI comparison (GAIC) framework 200.

GAIC framework 200 is capable of ingesting data generated by a search engine in response to a user query. In certain embodiments, GAIC framework 200 implements multiple machine learning models. In some embodiments, certain of the machine learning models are chained such that the output of one model is fed as input to another. A chain of interconnected machine learning models implemented by GAIC framework 200 may identify features that characterize attributes of items indicated in the user query. Another chain of machine learning models of GAIC framework 200 group like features, each group of like features characterizing a similar attribute of each of the items. One or more comparative machine learning models of GAIC framework 200 performs inter-feature comparisons of the grouped features, and based on the comparisons, a generative AI model generates a comparative search result report that is output to the user.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the Internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the Internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

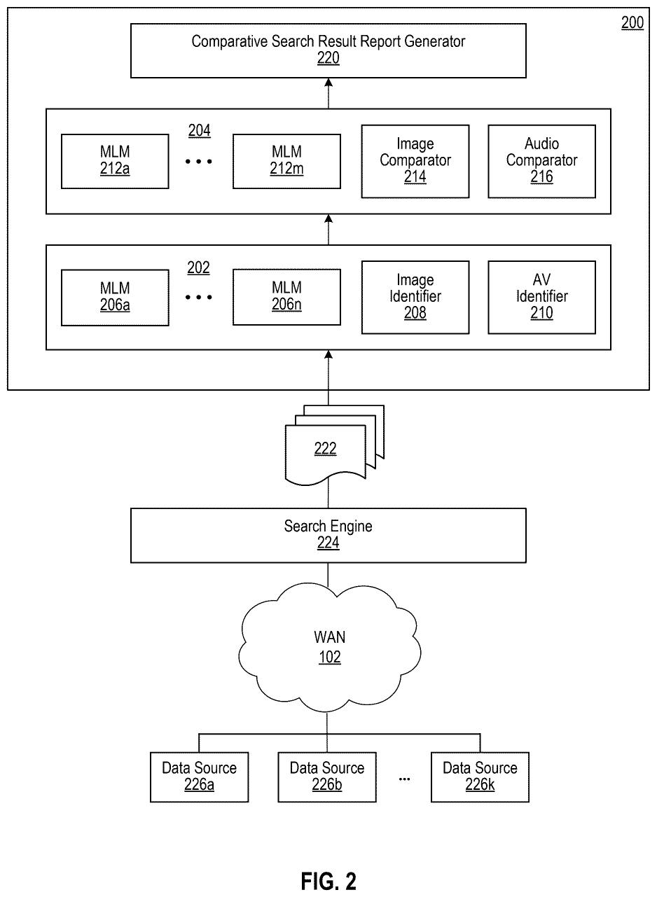

FIG. 2 illustrates an example architecture of GAIC framework 200. In the example architecture of FIG. 2, GAIC framework 200 illustratively includes feature identification layer 202, feature categorization layer 204, and comparative search result report generator 220. In certain embodiments, feature identification layer 202 includes interconnected machine learning models 206a through 206n, where n is a positive integer. Machine learning models 206a-206n may be interconnected by chaining the models such that the output of one model serves as the input to another. Chaining machine learning models 206a-206n enhances the performance of identification layer 202 by combining the respective strengths of the individually trained models. In some embodiments, machine learning models 206a-206n may be interconnected by stacking the models individually trained and using the outputs of n-1 models as the input to the nth model to implement ensemble learning. Optionally, feature identification layer 202 may also include image identifier 208 and/or audiovisual (AV) identifier 210. In some embodiments of feature identification layer 202, one or more of machine learning models 206a-206n may perform preprocessing of images that are fed as preprocessed images into identifier 208 for feature identification processing. Likewise, one or more machine learning models 206a-206n may perform preprocessing of audiovisual (AV) data that is fed as preprocessed data into AV identifier 210 for feature identification processing.

Feature categorization layer 204, in certain embodiments, includes interconnected machine learning models 212a through 212m, where m is a positive integer. Machine learning models 212a through 212m likewise may be interconnected by chaining or stacking the models to enhance the models' performance. At least one of machine learning models 212a-212m is a comparator machine learning model. Optionally, feature categorization layer 204 also may include image comparator 214 and/or audio comparator 216. GAIC framework 200, in certain embodiments, is implemented in software executable on the hardware of computer 101 operating in computing environment 100. Data 222 is collected by search engine 224 running on computer 101 for searching data sources 226a and 226b through 226k, where k is a positive integer. Data 222 is acquired by search engine 224 via WAN 102 and fed into feature identification layer 202 of GAIC framework 200.

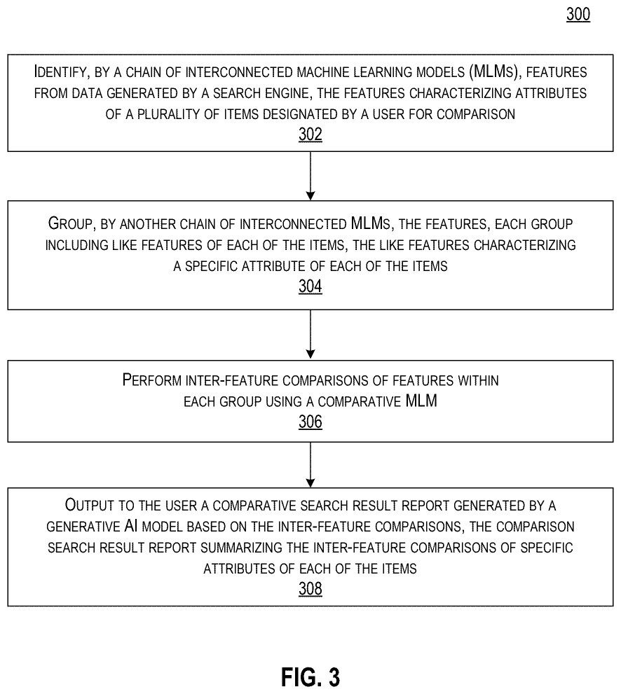

FIG. 3 illustrates an example method 300 of operation of GAIC framework 200 of FIG. 2. Referring to FIGS. 2 and 3 collectively, in block 302, features from data 222 generated by search engine 224 are identified by interconnected machine learning models 206a-206n. The features characterize attributes of a plurality of items designated by a user for comparison. The items themselves are identified by search engine 224 as part of the collecting of data 222 in response to a user search request. The items may, but need not, be objects. Rather, the items may be processes, for example. The items may be items found by search engine 224 searching the Internet or other collection of data sources.

Machine learning models 206a-206n include one or more models trained to perform feature extraction to extract keywords from data 222 in the form of text, the keywords indicating or describing features of the items. For example, if data 222 pertains to motorcycles, then machine learning models 206a-206n may automatically identify and extract features pertaining to various types of motorcycles, such as engine type, engine capacity, fuel type, ground clearance, and the like. Similarly, for example, if data 222 pertains to an appliance such as a refrigerator, then machine learning models 206a-206n may automatically identify and extract features such as storage capacity, number of doors, electricity consumption, number of chambers, and the like.

Data 222 alternatively or additionally may comprise images, in which event image identifier 208 may implement a machine learning model trained to perform feature extractions from images, the features including edges, texture, and shapes, for example. Event image identifier 208, in certain embodiments, implements a deep learning neural network trained to convert images to text. Thus, for example, if data 222 includes an image of a refrigerator, event image identifier 208 may convert the image into textual description, the text including a description of the number of doors of the particular refrigerator in the image.

Alternatively, or additionally, data 222 may include audio or audiovisual data, in which event AV identifier 210 may implement a machine learning model trained to analyze audio and/or visual data. One or more machine learning models 206a-206n may be an LLM trained to perform various natural language processing (NLP) tasks related to data 222. Features identified though processing by machine learning models 206a-206n as likely to provide strong contrasts for inter-feature comparisons items are retained while duplicative or overlapping features are discarded. The identified features are fed from feature identification layer 202 into feature categorization layer 204 for further processing.

In block 304, the identified features are grouped into groups of like or similar features of each of the items. The like or similar features characterize a specific attribute of each of the items. Each attribute may be the same or a comparable attribute of each item. The grouping is performed by machine learning models 212a-212m, which may be trained to categorize or classify features into distinct categories. For example, one or more machine learning models 212a-212m may be a deep learning neural network comprising multiple hidden layers (including linearly weighted variables input to non-linear activation functions) that are interposed between an input layer and an output layer and trained to categorize or classify the identified features. Machine learning models 212a-212m may be trained to implement feature selection, feature transformation, and/or other techniques for categorizing or classifying the features identified by machine learning models 206a-206n. Categorization of the identified features may also facilitate the display and filtering of the generated report (e.g., including matrix) described below.

Machine learning models 212a-212m include one or more comparative machine learning models trained to perform inter-feature comparisons of like features. For example, in comparing automotive features of various automobiles, a comparative machine learning model may compare prices of the various automobiles, another model may compare the vehicles gas milage rates, and still another model may compare another like feature characterizing another attribute of the vehicles. If, for example, a potential patient or medical researcher is interested in different surgical procedures for treating an ailment (e.g., cataracts), one or more comparative machine learning models among machine learning models 212a-212m may compare the success rates of different procedures (e.g., phacoemulsification, femtosecond laser, manual incision), the costs associated with each, and location where such procedures are performed.

If data 222 comprises visual images, image comparator 214 may implement a machine learning model trained to perform pattern recognition in comparing image features. For example, if data 222 comprises visual images of pipes, then image comparator 214 may generate images to compare the bends in available pipes.

If data 222 comprises audio data, audio comparator 216 may implement a machine learning model trained to perform pattern recognition in comparing audio features. Machine learning models 212a-212m, in some embodiments, also include models trained to perform sentiment analysis of information (e.g., reviews, commentary) pertaining to one or more features of each of the items.

In block 306, one or more comparative machine learning models among machine learning models 212a-212m, performs inter-feature comparison of like features within each group of features generated. Machine learning models 212a-212m, in some embodiments, also include models trained to perform sentiment analysis of information (e.g., reviews, commentary) pertaining to one or more features of each of the items.

One or more machine learning models 206a-206n and/or one or more learning models 212a-212m may be trained to identify duplicate or overlapping features and groups that do not provide sufficient information to warrant processing. The model(s) can resolve which duplicative or overlapping features and groups to discard by implementing different machine learning techniques. The techniques in certain embodiments include majority voting, in which select ones of the MLMs operating as an ensemble each make a prediction as to which features or groups are duplicative and discard the feature(s) or group(s) that the majority of the MLMs predict are merely duplicative. In other embodiments, the select MLMs may identify merely duplicative features or groups based on pretrained knowledge or content intelligence obtained through live-crawling over the Internet. The techniques may be applied to previously cached data representing the features and groups.

In block 308, comparative search result report generator 220 implements a generative AI model to generate a comparative search result report based on the inter-feature comparisons. The inter-feature comparisons may serve as prompts to which the generative AI model responds by summarizing each of the features of the different items and highlighting the way in which each item's features compare with those of the other items. In some embodiments, the generative AI model implemented by comparative search result report generator 220 is capable of performing content summarizations in generating comparative search result report generator 220. The generative AI model may also be trained to perform intent identification and/or other generative AI or NLP techniques as part of generating the comparative search result report. Once generated, the comparative search result report is output to the user.

In certain embodiments, the generative AI model implemented by comparative search result report generator 220 is configured to generate one or more images and/or illustrations based on the inter-feature comparisons. The image(s) and/or illustration(s) visually illustrate one or more of the inter-feature comparisons and are especially useful for highlighting complex comparisons. In certain embodiments, the image(s) and/or illustration(s) are generated based on cached metadata representing different items and features.

Comparative search result report generator 220, in certain embodiments, may implement one or more LLMs as well as one or more generative AI models in generating the comparative search result report. In certain embodiments, the features identified by feature identification layer 202 and categorized by feature categorization layer 204 are displayed in a tabular format on a GUI generated by GAIC framework 200.

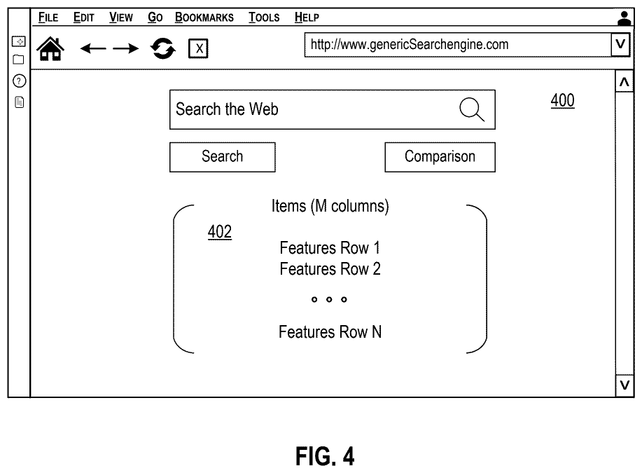

FIG. 4 illustrates an example graphical user face (GUI) 400 generated by GAIC framework 200 for presenting the comparative search result report to the user, according to certain embodiments. Illustratively, GUI 400 includes a “comparison” selector adjacent or near a standard “search” selector that initiates a search by a search engine. In response to the user selecting the “comparison” selector, search results (e.g., data 222) generated by the search engine are fed into GAIC framework 200. The selection of “comparison” thus initiates GAIC framework 200's performing the identifying, grouping, and inter-feature comparing that culminates in the output of the comparative search result report.

GUI 400 may include various interactive features enabling the user to view a multi-layer display of the comparative search result report generated by the generative AI model implemented by comparative search result report generator 220. The display may include tabs and sub-tabs for changing the display with GUI 400. GUI 400 may include various interactive features enabling the user to view a multi-layer display of the comparative search result report.

In certain embodiments, GAIC framework 200 uses GUI 400 to provide the user with a side-by-side comparison of features of the different items. The side-by-side comparison, in some embodiments, is in the form of N-by-M matrix 402. The M columns of matrix 402 correspond to the different items, and the N rows correspond to the items'features. Additionally, GUI 400 may provide the user with interactive capabilities for changing the format of a visual display of the comparative search result. The interactive capability may alleviate or lessen the burden of the user having to scroll through the report. For example, the user may elect to swap the rows and columns of N-by-M matrix 402.

In another embodiment, GAIC framework 200 also identifies, filters, and/or aggregates levels according to a user's interest is specific comparison results of the comparative search result report presented in GUI 400. An automatic default output may be presented by applying a likely optimal aggregation and filtering of levels to provide a concise summary of the comparison results to the user via GUI 400. Interactively, a user can change filters applied to the comparison result to highlight via GUI 400 items relating to the user's individual interest or requirements. Also interactively, the user can explore data at different levels of the search results by drilling down within the comparative search result report presented in GUI 400 to view items in the report in greater detail or, conversely, capture a higher level view by drilling up within the report.

In yet another embodiment, the user interactivity of GAIC framework 200 is further enhanced by providing the user with a capability to input a format or template according to which the comparative search result report is generated by the generative AI model implemented by comparative search result report generator 220. An MLM may be trained to infer the input format and determine the format's compatibility with the comparison output. Another MLM may be trained to restructure or reshape the search comparison output to fit into the input template or format. If the input template or format is incompatible, the user may be automatically informed via GUI 400. If the input template is found partially compatible, the partial report is presented via GUI 400 to the user along with the remaining report in a format predetermined by GAIC framework 200.

In certain embodiments, comparative search result report generator 220 includes an image generator for providing visual images with or without text comparing various features of the items. Additionally, or alternatively, comparative search result report generator 220 includes an audio generator for rendering the comparative search result report audibly. The comparative search result report may include a user-selectable feature to add audio commentary that describes intricate or complex aspects of the comparative search result report.

In some embodiments, GAIC framework 200 operates as a context-aware system. Operating in the background, GAIC framework 200 compares user searches launched by the user. In response to detecting, based on the comparing, that a current search matches a prior search by the user, GAIC framework 200 automatically responds by initiating the identifying, grouping, and performing inter-feature comparisons to generate the comparative search result report.

In other embodiments, GAIC framework 200 operates in the background to keep the comparative search result report current and up to date. GAIC framework 200 caches the comparative search result report. If there is a subsequent change in at least one feature that is detected based on newly retrieved data obtained via WAN 102 (e.g., the Internet), GAIC framework 200 responds by updating the comparative search result report. Accordingly, in certain embodiments, GAIC framework 200 caches the comparative search result report and updates the comparative search result report presented in GUI 400 in response to detecting a change in at least one feature based on newly retrieved data from a WAN such as the Internet.

The updated comparative search result report reflects any newly identified information. GAIC framework 200, in some embodiments, caches frequent search results to enable the generation of updatable comparative search result reports. In some embodiments, one or more machine learning models may be added to machine learning models 206a-206n and 212a-212m to identify similar content based on the frequency of searches and the similarity among searches (e.g., GAIC framework 200 is able to identify that the user's seeking a comparison among entertainment consoles is more likely than a comparison between brands of concrete).

In some embodiments, as a context-aware system, GAIC framework 200 incorporates geographic locations into a comparison of items. For example, GAIC framework 200 may be configured to allow a user to specify that the geographic location of items is a pertinent feature. If the user is performing a search to locate and purchase a particular item, for example, the user may indicate that the distance between the user's current location and the items'respective locations is a feature that should be factored into the comparative search result report.

The generative AI model implemented by comparative search result report generator 220, in certain embodiments, generates a metadata-rich output that provides a high level of interactivity between GAIC framework 200 and a user. For example, via GUI 400 the user may filter the comparative search result report. The user may drill-up or drill-down through the search result comparisons generated by GAIC framework 200. The results may be accompanied by images and/or AV output generated.

A user such as an advertising agency may use the search result comparisons generated as authentic comparisons for marketing and/or for advertising. A user such as an examination board may deploy GAIC framework 200 to compare exam answer sheets of students and to mark the exams accordingly so that subjectivity in marking based on the individual examiners'personal perspectives can be eliminated. GAIC framework 200 may be used to enable various e-commerce portals to rank newly listed products based on feature strengths in the absence of actual customer reviews. Accordingly, in certain embodiments, GAIC framework 200 is configured to integrate with multiple portals of a data communications network such as the Internet through multiple application programming interfaces (APIs) or comparable mechanisms. GAIC framework 200 in such arrangements may be used to generate comparisons of products or services across multiple listings on various websites to make up for a lack reviews of newly listed products or services. The comparisons may be generated by GAIC framework 200 using cached metadata representing features of the different products or services. Using cached metadata representing features of the different products or services, GAIC framework 200 may generate comparisons that enable a user to identify and distinguish between different brands and the producers or providers of the different brands.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A computer-implemented method, comprising:
identifying, by a chain of interconnected machine learning models (MLMs), features from data generated by a search engine, wherein the features characterize attributes of a plurality of items designated by a user for comparison;
grouping, by another chain of interconnected MLMs, the features, wherein each group includes like features of each of the items and wherein like features characterize a specific attribute of each of the items;
performing inter-feature comparisons of like features within each group using a comparative MLM; and
outputting to the user a comparative search result report generated by a generative AI model based on the inter-feature comparisons, wherein the comparative search result report summarizes the inter-feature comparisons of specific attributes of each of the items.

2. The computer-implemented method of claim 1, further comprising:
generating a graphical user interface (GUI) for presenting the comparative search result report to the user.

3. The computer-implemented method of claim 2, wherein the GUI presents a matrix in which the features and items are represented by rows and columns of the matrix.

4. The computer-implemented method of claim 2, further comprising:
caching metadata representing the items and features; and
providing the user interactive capabilities that include at least one of filtering, drilling down into, or drilling up in the comparative search result report based on the metadata.

5. The computer-implemented method of claim 1, wherein the features comprise at least one of image data or audio visual data.

6. The computer-implemented method of claim 1, further comprising:
comparing user searches by the user; and
in response to detecting, based on the comparing, that a current search matches a prior search by the user, automatically initiating the identifying, grouping, and performing inter-feature comparisons to generate the comparative search result report.

7. The computer-implemented method of claim 1, further comprising:
caching the comparative search result report; and
updating the comparative search result report in response to detecting a change in at least one feature based on newly retrieved data from a wide area network.

8. The computer-implemented method of claim 1, wherein the generative AI model generates at least one of an image or illustration based on the inter-feature comparisons to visually illustrate one or more inter-feature comparisons.

9. The computer-implemented method of claim 1, further comprising:
identifying and eliminating merely duplicative features or groups by select ones of the MLMs, wherein the select MLMs are trained to identify duplicative features and groups based on at least one of majority voting, pretrained knowledge, or content intelligence.

10. The computer-implemented method of claim 1, wherein the generative AI model generates the comparative search result report in a format constructed in response to input by the user and by determining compatibility and restructuring of content of the comparative search result report.

11. A computer system, comprising:
a processor set;
one or more computer-readable storage media; and
program instructions stored on the one or more computer-readable storage media to cause the processor set to perform operations including:
identifying, by a chain of interconnected machine learning models (MLMs), features from data generated by a search engine, wherein the features characterize attributes of a plurality of items designated by a user for comparison;
grouping, by the chain of interconnected MLMs, the features, wherein each group includes like features of each of the items and wherein each feature characterizes a specific attribute of each of the items;
performing inter-feature comparisons of like features within each group using a comparative MLM; and
outputting to the user a comparative search result report generated by a generative AI model, based on the inter-feature comparisons, wherein the comparative search result report summarizes the inter-feature comparisons of specific attributes of each of the items.

12. The computer system of claim 11, wherein the operations further include:
generating a graphical user interface (GUI) for presenting the comparative search result report to the user.

13. The computer system of claim 12, wherein the GUI presents a matrix in which the features and items are represented by rows and columns of the matrix.

14. The computer system of claim 12, wherein the operations further include:
caching the comparative search result report; and
updating the GUI for presenting the comparative search result report, wherein the updating is in response to detecting a change in at least one feature based on newly retrieved data from a wide area network.

15. The computer system of claim 11, wherein the features comprise at least one of images and audio-visual data.

16. The computer system of claim 11, wherein the operations further include:
comparing user searches by the user; and
in response to detecting, based on the comparing, that a current search matches a prior search by the user, automatically initiating the identifying, grouping, and performing inter-feature comparisons to generate the comparative search result report.

17. The computer system of claim 11, wherein the operations further include:
caching the comparative search result report; and
updating the comparative search result report in response to detecting a change in at least one feature based on newly retrieved data from a wide area network.

18. The computer system of claim 11, wherein the computer system is configured to integrate with multiple portals of a data communications network through multiple application programming interfaces (APIs).

19. A computer program product comprising:
one or more computer-readable storage media; and
program instructions stored on the one or more computer-readable storage media to perform operations comprising:
identifying, by a chain of interconnected machine learning models (MLMs), features from data generated by a search engine, wherein the features characterize attributes of a plurality of items designated by a user for comparison;
grouping, by the chain of interconnected MLMs, the features, wherein each group includes like features of each of the items and wherein each feature characterizes a specific attribute of each of the items;
performing inter-feature comparisons of like features within each group using a comparative MLM; and
outputting to the user a comparative search result report generated by a generative AI model, based on the inter-feature comparisons, wherein the comparative search result report summarizes the inter-feature comparisons of specific attributes of each of the items.

20. The computer program product of claim 19, wherein the operations further include:
generating a graphical user interface (GUI) for presenting the comparative search result report to the user.
